(19) United States
(12) Patent Application Publication
(10) Pub. No.: US 2007/0217498 A1
(43) Pub. Date: Sep. 20, 2007

(54) Transmission Circuit for a Transponder System Used for Transmitting a Digital Signal Via a Transmit Antenna

(75) Inventor: Bernard Tenconi, Nendingen (DE)

Correspondence Address: CONTINENTAL TEVES, INC., ONE CONTINENTAL DRIVE, AUBURN HILLLS, MI, 48326-1581, US

(73) Assignee: Conti Temic Microelectronic GMBH

(21) Appl. No.: 11/579,743

(22) PCT Filed: Apr. 14, 2005
(86) PCT No.: PCT/DE05/00680

§ 371 Date: Nov. 8, 2006

(30) Foreign Application Priority Data
May 8, 2004 (DE) 10 2004 022 839.6

(51) Int. Cl. G06K 7/00

(52) U.S. Cl. 375/238

(57) ABSTRACT

The invention relates to a transmission circuit for a transponder system used for transmitting a digital signal via a transmit antenna for radio waves having a predefined carrier frequency, e.g. to be utilized for keyless access control systems in motor vehicles. In order to be able to operate said transmission circuit across a wide range of operating voltages while keeping losses small, a PWM signal generator is provided for generating a pulse width-modulated signal having a given clock frequency which is greater, preferably by a multiple, than the frequency of the digital signal while the digital signal is superimposed on the PWM signal so as to transmit said digital signal. The PWM signal controls switched-mode semiconductor switches, a bandpass prefilter being mounted upstream of the transmit antenna. Preferably, a control circuit is provided for adjusting the pulse/pause ratio of the PWM signal and adjusting the current flowing through the transmit antenna to a setpoint value. A test sequence of the PWM signal is emitted for a given test period while the current flowing through the transmit antenna is detected before the digital signal is transmitted, and the pulse/pause ratio of the PWM signal is regulated in such a way that the current approximately corresponds to the setpoint value, whereupon the digital signal is transmitted for a given transmission period while the pulse/pause ratio is kept constant.

### BACKGROUND OF THE INVENTION

The invention relates to a transmission circuit for a transponder system used for transmitting a digital signal via a transmit antenna (2) for radio waves having a predefined carrier frequency.

Transponder systems are used for transmitting a digital signal, for example an identification code for access control to motor vehicles or to similar data. For data transmission radio waves are used having a given carrier frequency, the necessary range being relatively small and the transmission circuit for cost reasons having to be very cheap for the batch use. Moreover, adherence to corresponding requirements with regard to the transmission power, band width and attenuation of harmonic waves is required for an official radio authorization.

So far, for this reason, for inciting the transmit antenna of transponder systems as a rule semi-conductor transistors have been used in the class-A-operation with defined leading edges, i.e. not in the switch mode, as the switch mode results in considerable harmonic wave interferences. In addition, so far the operation voltage was to be kept relatively constant, what is problematic in particular with vehicle applications, the more so as in future vehicle manufacturers will use partly deviating vehicle electrical system voltages.

From DE 198 39 802 A1 a method and a device for generating an amplitude-modulated carrier signal is known. Here, the amplitude-modulated carrier signal is generated by filtering a digital, pulse width-modulated signal.

It is the object of the invention to introduce a transmit circuit, which can be used at a wide range and which is still low-priced and corresponds to the approval requirements.

This object is achieved by a transmission circuit for a transponder system used for transmitting a digital signal via a transmit antenna (2) for radio waves having a predefined carrier frequency, wherein a PWM signal generator (6) is provided for generating a pulse width-modulated signal having a given clock frequency and for transmitting said digital signal while the digital signal is superimposed on the PWM signal, the signal generated in this manner triggers via a level converter (3) two pushpull switch mode semiconductor switches (T1, T2), one semiconductor switch (T1) being connected to the supply voltage and the other semiconductor switch (T2) to the mass potential and the two semiconductor switches (T1, T2) with the respective other connection to the input of a bandpass prefilter (1), the transmit antenna (2) is switched at the output of the bandpass prefilter (1) a control circuit for the current (I_Ant) flowing through the transmit antenna (2) is provided, the current flowing through the transmit antenna (R_I_Ant) being detected and being compared in a comparator with a setpoint value (I) and in case of a deviation (J), characterized in that the control circuit generates a control signal (K) for adapting the pulse/pause ratio (D) of the PWM signal to the PWM signal generator, before the digital signal is transmitted a test sequence of the PWM signal is emitted for a given test period (P2) while the current flowing through the transmit antenna is detected, and the pulse/pause ratio of the PWM signal is regulated in such a way that the current approximately corresponds to the setpoint value, and subsequently, the digital signal is transmitted for a given transmission period (P3) while the pulse/pause ratio is kept constant.

Thus, semi-conductor switches are used in the switch mode to incite the transmit antenna and are switched pulse width-modulated in the PWM operation, the circuit in relation to conventional circuits for transponders showing clearly smaller losses and on the other hand being usable over a relatively large voltage range. Therefore, the pulse-width ratio determines the current flowing through the transmit antenna and thus the transmit power. For eliminating the harmonic waves interferences a bandpass prefilter is mounted upstream of the transmit antenna.

Preferably, the current is detected via the transmit antenna, and is compared to a setpoint value and the pulse/pause ratio is regulated in such a way that the current corresponds to the setpoint value. Even fluctuations in the power supply, as they cannot be excluded in vehicle applications, as well as temperature influences can be balanced thereby.

As during transmission of the digital signal the current flowing through the transmit antenna is currently fluctuating, it is proven to be especially advantageous to suspend the regulation for the transmission period and to keep the pulse/pause ratio constant. Therefore, before transmission a test sequence of the PWM signal is activated for a given test period, so that the control circuit can be established.

Transmission of the digital signals is effected in this case within given transmission periods, between which a test sequence each is emitted and the control circuit is re-adjusted.

Next to the pulse/pause ratio in the PWM signal generator also the regulation itself is kept to the adjusted value during the transmission period and is separated from detection of the current, so that also within the control circuit the adjusted value is kept for the transmission period and thus is available as a default value at the end of the transmission period and at activation of the test sequence and at regulation . Thereby the settling time is clearly reduced.

In order to cut short also when switching on this settling, the control circuit is preferable pre-adjusted to a default value.

### BRIEF DESCRIPTION OF THE DRAWINGS

In the following the invention is described on the basis of examples of embodiment and figures. A short description of the figures:

FIG. 1 a functional diagram of the transmission circuit

FIG. 2 a functional diagram of the regulation

FIG. 3 a flow-chart of the PWM regulation

FIG. 4 a substitute circuit for simulation of the prefilter and transmit antenna

### DETAILED DESCRIPTION OF THE DRAWINGS

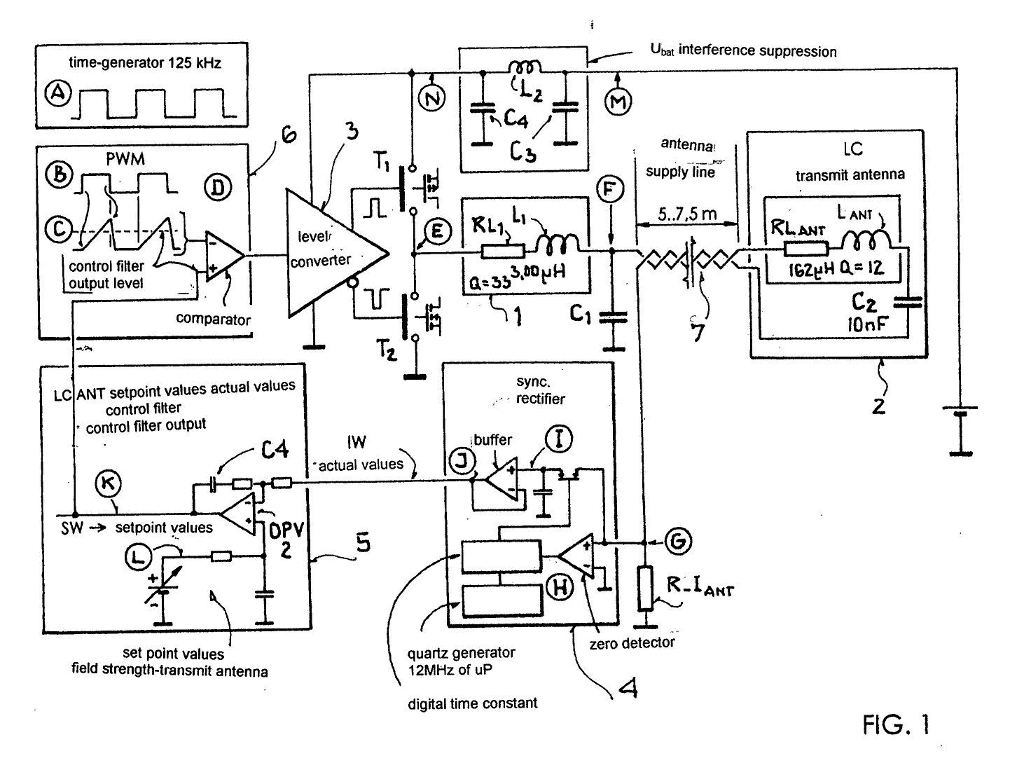

FIG. 1 shows a functional diagram of a transmission circuit of a transponder system for transmitting a digital signal, here an identification code for access control to a motor vehicle.

For a simple and energy-saving triggering a PWM trigger signal is generated by the PWM member 6 to a push-pull switch step 3. In order to still generate a transmit signal without interfering harmonic waves, a prefilter 1 is used for the antenna 2. With this double circuit filter it can be achieved that already the third harmonic wave is attenuated by 45 dB at the first circuit 1 (position F). In this way the connection 7 from the control device to the transmit antenna is not burdened with unnecessary harmonic waves.

The second circuit 2 consists of the inductance LAnt and the capacity CAnt. Here, this serial resonance circuit is tuned e.g. to the resonant frequency f0=125 kHz. LAnt consists e.g. of a ferrite rod, which radiates a magnetic emission field.

It must be noted that theoretical as well as practical results lead to an attenuation of over 65 dB of the third harmonic wave flowing through the transmit antenna circuit (current as well as voltage). Thus, all necessary stipulations for radio authorization are adhered to.

The double bandpass filter consists of a pre-circuit 1 with L1, C1 and of a second filter circuit 2 of LAnt, C2. The complex LAnt-C2 is connected at a distance of e.g. 5-7.5 m to the control device via the antenna supply line 7. This double-PI bandpass filter is driven with a square-wave signal at the measurement point E via the CMOS-transistor pair T1 and T2. The transistors T1 and T2 are used as switches and are controlled in turn via a level converter.

At the measurement point G an AC-voltage is generated via the series resistance R_IAnt. It is the reproduction of the current flowing through the transmit antenna (LAnt). This voltage is rectified as a peak-DC-value via a synchronous rectifier. The DC-voltage is present at the measurement point J and arrives at a regulation filter.

Then, the control behavior of the current in the transmit antenna (LAnt) is as follows:

A time basis generator generates a periodic 125-kHz-square-wave-digital-signal (signal B). Via this signal B in turn a ramp (signal C) is generated via the positive flank and is supplied to the inverted input of a comparator. A voltage dependent from the amplitude of the LAnt-current is transferred from the control filter to the non-inverted input of this comparator.

The setpoint value of the antenna current and the field strength (VA), respectively, is given via the measurement point L. An operation amplifier serves as a control filter. Assuming that the antenna current increases, the AC-voltage will also increase at the measurement point G. Thus, the DC-voltage will also rise proportionally at the measurement point J. Thereby, the inverted input of the OPV2 faces a more positive voltage than the voltage setpoint value L at the non-inverted input.

This voltage difference is integrated via R1 and C4. By means of this, the output voltage of the control filter decreases at the measurement point K. The voltage of the measurement point K does not reach the non-inverted input of the ramp comparator, and the ramp level at the measurement point C decreases. Thus, at the measurement point D the pulse-width ratio to the repetition period (8 μs=125 kHz) is smaller.

By means of this, point E will assume the same voltage value via the level converter and the switches T1 and T2. As the positive impulse has become smaller, the energy at the double-PI-bandpass filter has been reduced. This results in that the voltage at the measurement point G (illustration of the current flowing through the transmit antenna) has been reduced. As above-mentioned, consequently also the DC-voltage at the measurement point J decreases. The difference between IW (actual value) and SW (setpoint value) is reduced, so that it is adjusted via the measurement point K and the measurement point D, respectively, to the correct value.

The precision of the current flowing through the transmit antenna and the field strength, respectively, finally depends on the offset of the OPV1 and OPV2 and on the accuracy of the DC-voltage temperature coefficient and of the absolute setpoint value accuracy.

The control apparatus permits a precision of the antenna current and of the field strength, respectively, of approx. 0.5%.

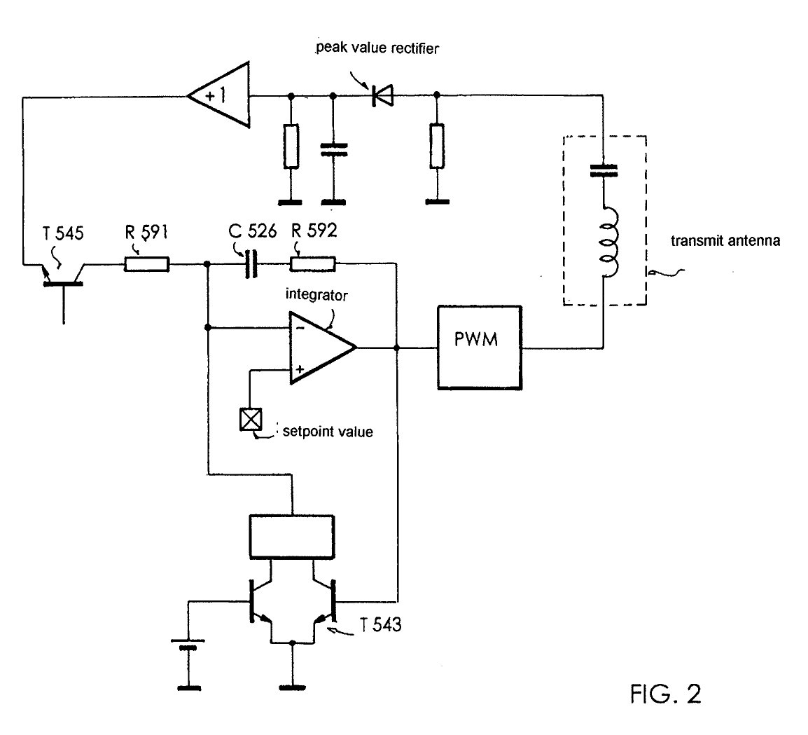

In the following the control filter is to be described in detail on the basis of the circuit arrangement according to FIG. 2.

The current is detected by the bandpass filter via a peak value rectifier (diode). The obtained voltage is proportional to the transmit antenna current and is positive. This voltage flows through T545 and R591 to the inverted input of the OPV 21, which is switched as an integration filter.

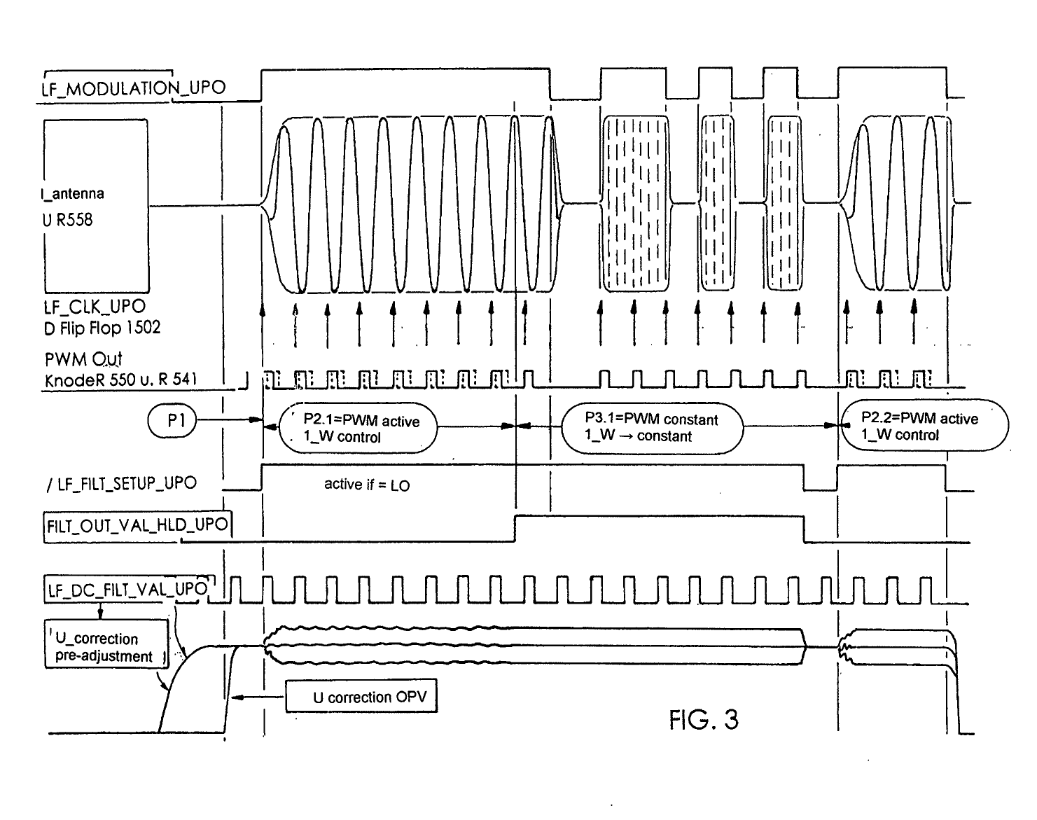

The higher the current flowing through the filter (or transmit antenna), the more the voltage decreases at the output of the integrator 21. Thus, C526 charges accordingly. This voltage, known as “U_correction”, is the input to PWM. The pulse-width at the output of the PWM becomes the smaller, the higher the information jump over the peak value rectifier is gained. The control (phase P2 in FIG. 3) takes places by the voltage of the setpoint value and the actual value approximating at the input of the integrator such that almost no current flows through R591. Thus, the DC-actual value approximates the setpoint value. The accuracy of the actual value is merely dependent on the offset voltage of the integrator.

Now, on the basis of the flow-chart according to FIG. 3 the sequence of the control is to be described in detail.

So that with a new start or an undefined state of operation for example after a certain transmission period the actual value U_correction adjusts as fast as possible to the command variable, during the phase P1 the integration filter (21 in FIG. 2) is pre-adjusted to a rough value U0 (cp. FIG. 2). This is effected by means of the signal LF_DC_FILT_VAL_UPO (cp. FIG. 3) until LF_FILT_SETUP_UPO=LOW.

For leaving the pre-adjustment and the activation of the PWM after release by the signal LF_MODULATION_UPO and LF_FILT_SETUP_UPO=HIGH the transistor T545 (cp. FIG. 2) becomes conductive via (FILT_OUT_VAL_HLD_UPO=LOW), i.e. the control behavior in phase P2 becomes active as above.

Consequently, in phase P2.1 the carrier signal is transmitted unmodulated (PWM out) and the current flowing through the antenna (I_antenna) is detected and re-adjusted, as can be seen from the fluctuations at U_correction. The fluctuations of I_antenna are barely visible in FIG. 3, but do exist in practice.

As during the given duration this U_correction as a rule adjusts to the correct value, T545 becomes highly resistive. By means of this, U_correction maintains its previously adjusted value, as C526 maintains its charge, if a current neither flows via R591 nor via the input resistance of the OPV.

In the subsequent transmit phase P3.1 the switch T545 is switched off (signal FILT_OUT_VAL_HLD_UPO=HIGH in FIG. 3) and thus the PWM-ratio is retained until the data transmission cycle is terminated.

From this point in time data bits of more than 100% modulation of the carrier can be transmitted. As a switching on or off of the carrier lies far over the time constant of the carrier (t=R591*·C526), it is avoided by the previous measures and by a correspondingly measured duration of a data transmission cycle that a beat of U_correction and thus of the carrier amplitude takes place.

After the given duration P3 of a data transmission cycle the control circuit is again released, i.e. a new test phase P2 is activated, i.e. the switch T545 is closed and the unmodulated carrier signal is emitted for a given duration and thereby the transmit current I_antenna is adjusted to the setpoint value, before then the next transmit phase P3.2 follows, etc.

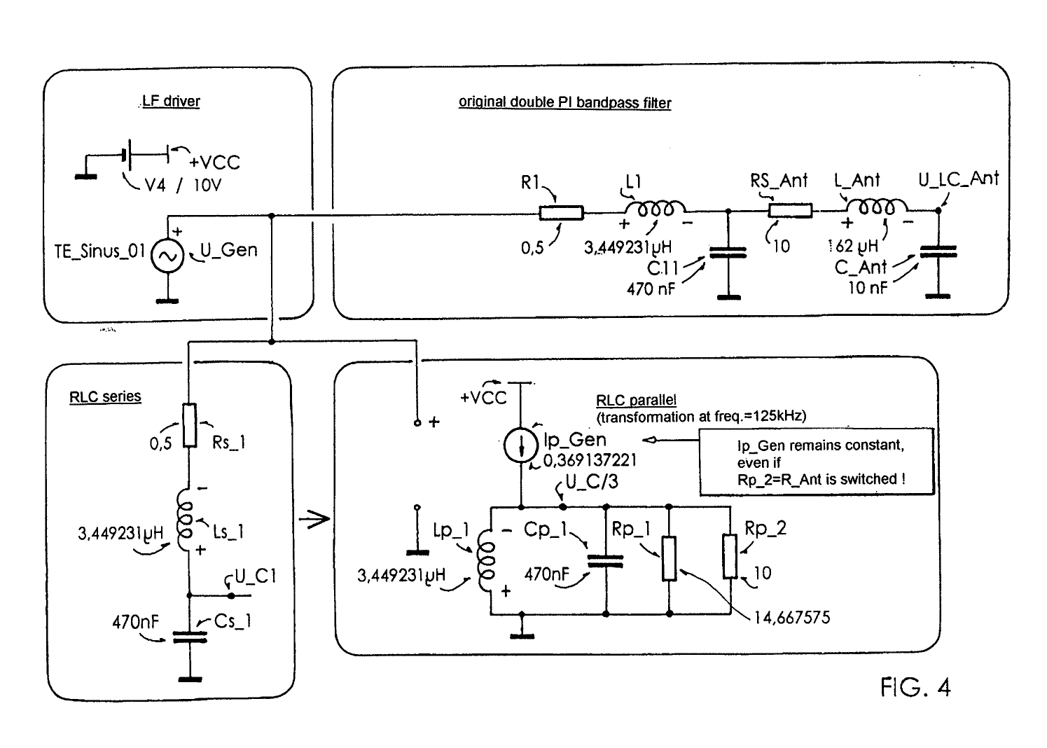

For determining the pre-filter parameters by simulation of the behavior of pre-filter and transmit antenna, in addition the circuit for the carrier frequency of 125 kHw chosen in this case has been transformed into an RLC-parallel circuit, as this is shown in FIG. 4. The size of the substitute switching elements then results from the output values according to the formulas shown there.

In order to be able to operate the transmission circuit across a wide range of operating voltages while keeping losses small, a PWM signal generator is provided for generating a pulse width-modulated signal having a given clock frequency which is greater, preferably by a multiple, than the frequency of the digital signal. For transmission of the digital signal it is superimposed on the PWM signal, i.e. a corresponding lower-frequent amplitude modulation takes place on the PWM-base signal. The PWM signal controls switched-mode semiconductor switches, a bandpass prefilter being mounted upstream of the transmit antenna.

1-6. (canceled)

7. A transmission circuit for a transponder system used for transmitting a digital signal via a transmit antenna (2) for radio waves having a predefined carrier frequency comprising:
a PWM signal generator (6) for generating a pulse width-modulated signal having a given clock frequency and for transmitting a digital signal while the digital signal is superimposed on the PWM signal;
a level converter (3) and two push/pull switch mode semiconductor switches, wherein the signal generated triggers via the level converter (3) the two push/pull switch mode semiconductor switches (T1, T2), one semiconductor switch (T1) being connected to the supply voltage and the other semiconductor switch (T2) to the mass potential and the two semiconductor switches (T1, T2) with the respective other connection to the input of a bandpass prefilter (1);
a transmit antenna (2) is switched at the output of the bandpass prefilter (1);
a control circuit for current (I_Ant) flowing through the transmit antenna (2); and
a comparator, wherein the current flowing through the transmit antenna (R_I_Ant) is detected and compared in a comparator with a setpoint value (I) and in case of a deviation (J) and the control circuit generates a control signal (K) for adapting the pulse/pause ratio (D) of the PWM signal to the PWM signal generator, and before the digital signal is transmitted a test sequence of the PWM signal is emitted for a given test period (P2) while the current flowing through the transmit antenna is detected, and the pulse/pause ratio of the PWM signal is regulated in such a way that the current approximately corresponds to the setpoint value, and subsequently, the digital signal is transmitted for a given transmission period (P3) while the pulse/pause ratio is kept constant.

8. A transmission circuit according to claim 7, wherein the current is detected by a peak value rectifier circuit and is supplied to an integration filter (21) with a threshold value comparator, the output signal of this threshold value comparator controlling the pulse/pause ratio of the PWM signal generator.

9. A transmission circuit according to claim 8, wherein between the peak value rectifier circuit detected and integration filter a controllable switching means (T545) is provided and that this is open during the transmission period and the value last adjusted is maintained at least approximately.

10. A transmission circuit according to claim 7, wherein an integration filter (21) with threshold value comparator comprises an operation amplifier with a condenser (C526) and a resistance (R592) in the feedback path from the output to the inverted input, the time constant of the integration filter being greater than the transmission period.

11. A transmission circuit according to claim 7, wherein at the start of operation (P1) the integration filter is pre-adjusted directly to a given value and subsequently the transmission of the test sequence (P2) is activated.

12. A transmission circuit according to claim 7, wherein the transmission circuit is used for a transponder for wireless data transfer between a central device in the motor vehicle and a portable identification transmitter.
